(19) United States
(12) Patent Application Publication
(10) Pub. No.: US 2010/0119194 A1
(43) Pub. Date: May 13, 2010

(54) Optical Waveguide With Reflector

(75) Inventors: Michael Allen Seigler, Pittsburgh, PA (US); Changbao Ma, Arlington, VA (US)

Correspondence Address: PIETRAGALLO GORDON ALFANO BOSICK & RASPANTI, LLP, ONE OXFORD CENTRE, 38TH FLOOR, 301 GRANT STREET, PITTSBURGH, PA, 15219-6404, US

(73) Assignee: Seagate Technology LLC, Scotts Valley, CA (US)

(21) Appl. No.: 12/270,028

(22) Filed: Nov. 13, 2008

(51) Int. Cl. G02B 6/26; G02B 6/02

(52) U.S. Cl. 385/32; 385/126

(57) ABSTRACT

An optical waveguide includes a core layer having a first core section and a second core section, wherein the first core section is non-axially aligned with the second core section. The optical waveguide also includes a cladding layer disposed about the core layer and a reflector in optical communication with the core layer for directing an electromagnetic wave from the first core section to the second core section.

### BACKGROUND

Heat assisted magnetic recording (HAMR) requires that a thermal source be brought into close proximity to a magnetic writer. HAMR designs utilize an intense near field optical source to elevate the temperature of the storage media. When applying a heat or light source to the medium, it is desirable to confine the heat or light to the track where writing is taking place and to generate the write field in close proximity to where the medium is heated to accomplish high areal density recording.

A waveguide is an optical component that can provide for directing or guiding an electromagnetic wave. Data storage systems often incorporate optical components to assist in the recording of information. Such systems may include, for example, optical recording systems, magneto-optical recording systems or other thermal assisted type recording systems. There is an increased emphasis on improving the areal densities of data storage systems. Thus, all components of data storage systems are being improved and new components are being incorporated into data storage systems to achieve higher areal densities.

### SUMMARY

An aspect of the present invention is to provide an optical waveguide that includes a core layer having a first core section and a second core section, wherein the first core section is non-axially aligned with the second core section. The optical waveguide also includes a cladding layer disposed about the core layer and a reflector in optical communication with the core layer for directing an electromagnetic wave from the first core section to the second core section.

Another aspect of the present invention is to provide an apparatus that includes a core layer for guiding an electromagnetic wave in a first propagation direction and a second propagation direction, a cladding layer disposed at least partially about the core layer, and a reflector in optical communication with the core layer for directing the electromagnetic wave from the first propagation direction to the second propagation direction.

A further aspect of the present invention is to provide an optical waveguide that includes a core layer for guiding an electromagnetic wave in a first direction and a second direction, a cladding layer disposed about the core layer, and means for directing the electromagnetic wave from the first direction to the second direction.

A further aspect of the present invention is to provide an apparatus that includes means for storing data, means for reading and/or writing data in association with the means for storing data, and an optical waveguide for guiding an electromagnetic wave to the means for reading and/or writing data, the optical waveguide including an internal reflector for changing the propagation direction of the electromagnetic wave.

These and various other features and advantages will be apparent from a reading of the following detailed description.

### DRAWINGS

FIG. 1 is a pictorial representation of a system, in accordance with an aspect of the invention.

FIG. 2 is a plan view of an actuator arm, in accordance with an aspect of the invention.

FIG. 3 is an enlarged partial sectional view illustrating a waveguide of FIG. 2, in accordance with an aspect of the invention.

FIG. 4 is an enlarged partial sectional view illustrating a waveguide, in accordance with another aspect of the invention.

FIG. 5 is an enlarged partial sectional view illustrating a waveguide, in accordance with yet another aspect of the invention.

FIG. 6 is a schematic representation of a system, in accordance with an aspect of the invention.

### DETAILED DESCRIPTION

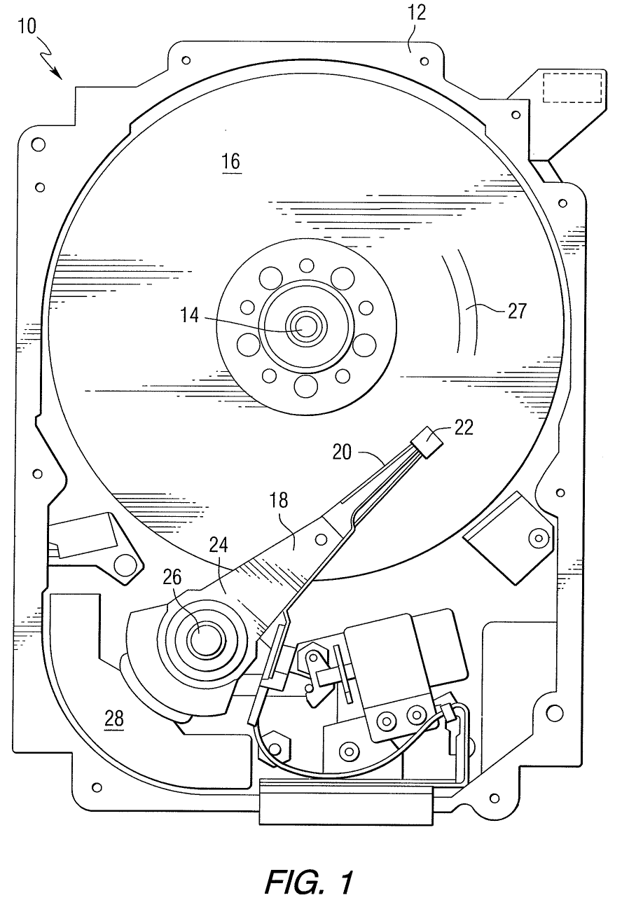

FIG. 1 is a pictorial representation of a system 10 that can include aspects of this invention. The system 10 includes a housing 12 (with the upper portion removed and the lower portion visible in this view) sized and configured to contain the various components of the system 10. The system 10 includes a spindle motor 14 for rotating at least one disc 16 within the housing 12. At least one actuator arm 18 is contained within the housing 12, with each arm 18 having a first end 20 with a slider 22, and a second end 24 pivotally mounted on a shaft by a bearing 26. An actuator motor 28 is located at the arm's second end 24 for pivoting the arm 18 to position the slider 22 over a desired sector 27 of the disc 16. The actuator motor 28 is regulated by a controller, which is not shown in this view and is well known in the art.

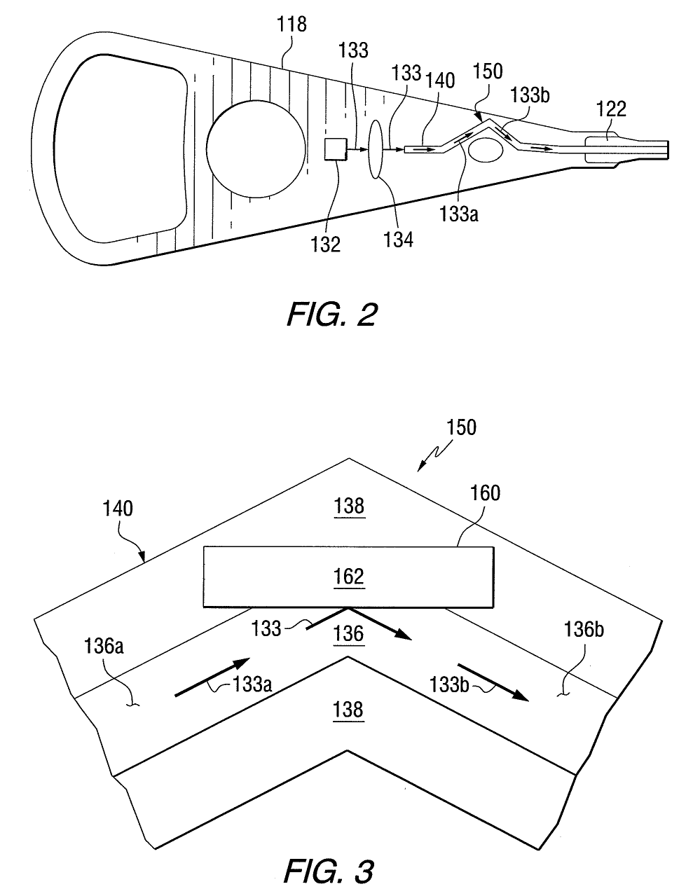

FIG. 2 is a plan view of an actuator arm 118 having a laser module 132 mounted thereon, in accordance with an aspect of the invention. The laser module 132 directs an electromagnetic wave 133 to an optical waveguide 140. An optical component such as, for example, a lens 134, may be positioned between the laser module 132 and the waveguide 140 to focus the wave 133. The waveguide 140 is used to conduct, i.e. guide or direct, the electromagnetic wave 133 from the laser module 132 to a slider 122. From the waveguide 140, the electromagnetic wave 133 can be coupled into the slider 122 and directed onto an adjacent data storage medium for heating an area of the data storage medium (not shown in FIG. 2).

As illustrated in FIGS. 2 and 3, the waveguide 140 includes at least one bend or turn, generally indicated by reference number 150. The ability to bend or turn the waveguide 140 is desirable for when at least of a portion of the waveguide 140 needs to extend in more than one direction, i.e. at least a portion of the waveguide may extend non-linearly and/or from one plane to another plane. In one aspect, the waveguide 140 may be a flexible optical waveguide.

Referring to FIG. 3, the waveguide 140 includes a core layer 136 through which the electromagnetic wave 133 propagates. The core layer 136 may be formed of, for example, polymethylmethacrylate, polystyrene, polycarbonate, SU8 or silicone polymers such as polysiloxanes or siloxanes. High index of refraction particles may be added to the waveguide material to adjust the index of refraction of the material. The waveguide 140 also includes a cladding layer 138 that is at least partially disposed about the core layer 136. The cladding layer 138 may be formed of, for example, polymethylmethacrylate, polystyrene, polycarbonate, SU8 or silicone polymers such as polysiloxanes or siloxanes.

As illustrated in FIG. 3, the waveguide 140 includes a reflector 160 that is positioned in optical communication with the with the core layer 136 for directing the electromagnetic wave 133 from a first core section 136a of the core layer 136 to a second core section 136b of the core layer 136. In one aspect, the core layer 136 is continuous from the first core section 136a to the second core section 136b. In one aspect, the first core section 136a is non-axially aligned with the second core section 136b and, thus, the reflector is positioned for redirecting the electromagnetic wave 133. For example, the electromagnetic wave 133 may have a first segment, generally identified as 133a, which propagates in a first direction within the first core section 136a that is redirected by the reflector 160 to propagate in a second direction, as generally indicated by a second segment 133b of the wave 133, within the second core section 136b.

The reflector 160 can be, for example, a trench 162 that is formed by etching a trench 162 into the waveguide 140, stamping a trench 162 into the waveguide 140 or molding the waveguide 140 with a trench 162 in the mold. In one aspect, the reflector 160 may be an empty trench 162, i.e. filled with only air, such that it will reflect the electromagnetic wave 133 with a waveguide-air interface and, thus, the trench 162 does not need to be filled in order to function as a reflector for redirecting or guiding the wave 133.

In another aspect, the trench 162 may be filled to keep it from collecting particles and reducing the reflectivity over the life-time of the waveguide 140. For example, the reflector 160 can be formed using metals (e.g., Au, Ag, Al, Cu, Cr), metal oxide dielectrics (e.g., SiO2, Ta2O5, Al2O3, Si3N4, SiON, AlON, TiO2), dielectric polymers (e.g., polymethylmethacrylate, polystyrene, polycarbonate, SU8 or silicone polymers such as polysiloxanes or siloxanes) porous materials (e.g., any of the waveguide materials can be fabricated with voids to adjust the index of refraction of the material), metal colloid polymers (e.g., particles may be added to any of the waveguide materials to adjust the index of refraction of the material), or any combinations of these materials. An advantage of the polymer option would be its physical flexibility. In one aspect, metal or dielectric particles could be mixed with the polymer to form a colloid to achieve the appropriate optical properties.

In one aspect of the invention as shown, for example, in FIG. 3, the reflector 160 may be positioned at least partially in the core layer 136. In another aspect of the invention, the reflector 160 may be positioned at least partially in the cladding layer 138. The positioning of the reflector 160 within the waveguide 140 is chosen to provide the desired optimum redirecting of the electromagnetic wave 133.

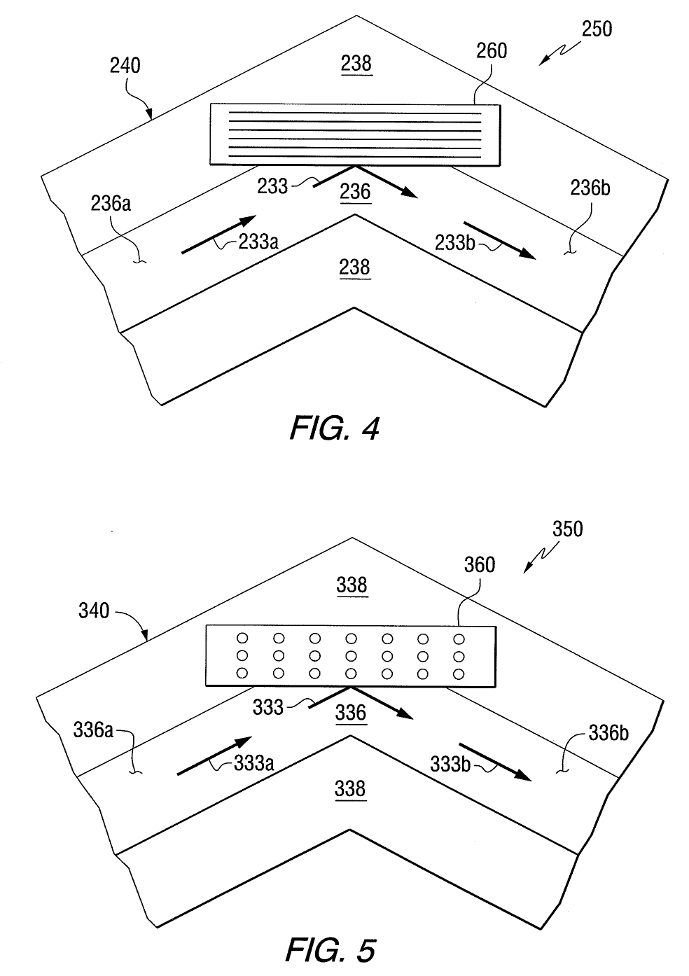

FIG. 4 illustrates a waveguide 240 that includes at least one bend or turn, generally indicated by reference number 250, in accordance with another aspect of the invention. The waveguide 240 includes a core layer 236 through which the electromagnetic wave 333 propagates. The waveguide 240 also includes a cladding layer 238 that is at least partially disposed about the core layer 236. The waveguide 240 further includes a diffraction grating 260 which serves as a reflector. Specifically, the grating 260 is positioned in optical communication with the with the core layer 236 for directing the electromagnetic wave 233 from a first core section 236a of the core layer 236 to a second core section 236b of the core layer 236. In one aspect, the core layer 236 is continuous from the first core section 236a to the second core section 236b. In one aspect, the first core section 236a is non-axially aligned with the second core section 236b and, thus, the grating 260 is positioned for redirecting the electromagnetic wave 233. For example, the electromagnetic wave 233 may have a first segment, generally identified as 233a, which propagates in a first direction within the first core section 236a that is redirected by the grating 260 to propagate in a second direction, as generally indicated by a second segment 233b of the wave 233, within the second core section 236b.

FIG. 5 illustrates a waveguide 340 that includes at least one bend or turn, generally indicated by reference number 350, in accordance with another aspect of the invention. The waveguide 340 includes a core layer 336 through which the electromagnetic wave 333 propagates. The waveguide 340 also includes a cladding layer 338 that is at least partially disposed about the core layer 336. The waveguide 340 further includes a photonic crystal reflector 360. Specifically, the photonic crystal reflector 360 is positioned in optical communication with the with the core layer 336 for directing the electromagnetic wave 333 from a first core section 336a of the core layer 336 to a second core section 336b of the core layer 336. In one aspect, the core layer 336 is continuous from the first core section 336a to the second core section 336b. In one aspect, the first core section 336a is non-axially aligned with the second core section 336b and, thus, the photonic crystal reflector 360 is positioned for redirecting the electromagnetic wave 333. For example, the electromagnetic wave 333 may have a first segment, generally identified as 333a, which propagates in a first direction within the first core section 336a that is redirected by the photonic crystal reflector 360 to propagate in a second direction, as generally indicated by a second segment 333b of the wave 333, within the second core section 336b.

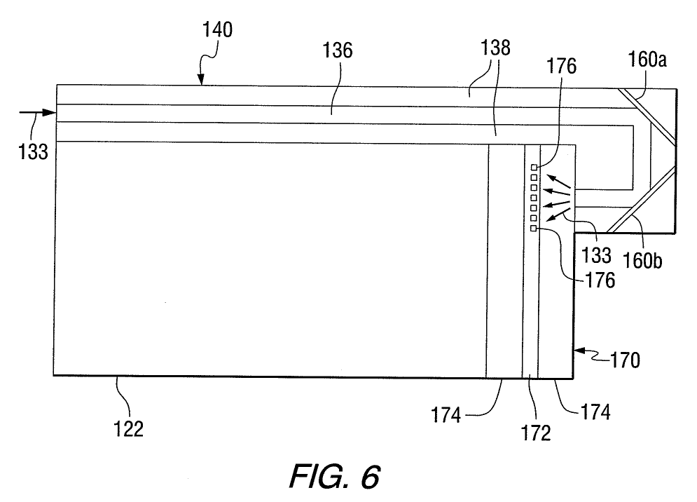

FIG. 6 is a schematic representation of a system, in accordance with an aspect of the invention. Specifically, a slider 122 (such as shown, for example, in FIG. 2) includes a waveguide transducer 170 formed on an end thereof. The waveguide transducer 170 includes a core layer 172 through which an electromagnetic wave propagates. The waveguide 170 also includes a cladding layer 174 that is at least partially disposed about the core layer 172. The waveguide 170 further includes a diffraction grating 176 for coupling the electromagnetic wave 133 into the core layer 172.

Still referring to FIG. 6, the system also includes the waveguide 140 that includes the core layer 336 through which the electromagnetic wave 333 propagates and the cladding layer 138 that is at least partially disposed about the core layer 136. The waveguide 140 also includes a first reflector 160a and a second reflector 160b that are positioned in optical communication with the core layer 136 for directing the electromagnetic wave 133 toward the grating 176. It will be appreciated that additional reflectors can be provided in the waveguide 140 for directing or guiding the wave 133 in more than one direction, i.e. non-linearly and/or from one plane to another plane, as desired.

The implementation described above and other implementations are within the scope of the following claims.

What is claimed is:

1. An optical waveguide, comprising:
a core layer having a first core section and a second core section, wherein the first core section is non-axially aligned with the second core section;
a cladding layer disposed about the core layer; and
a reflector in optical communication with the core layer for directing an electromagnetic wave from the first core section to the second core section.

2. The optical waveguide of claim 1, wherein the reflector is a diffraction grating.

3. The optical waveguide of claim 1, wherein the reflector is a photonic crystal reflector.

4. The optical waveguide of claim 1, wherein the reflector is formed of air, Au, Ag, Al, Cu, Cr, SiO2, Ta2O5, Al2O3, Si3N4, SiON, AlON, TiO2, dielectric polymers or metal colloid polymers.

5. The optical waveguide of claim 1, wherein the core layer is continuous from the first core section to the second core section.

6. The optical waveguide of claim 1, wherein the reflector is positioned at least partially in the core layer.

7. The optical waveguide of claim 1, wherein the reflector is positioned at least partially in the cladding layer.

8. An apparatus, comprising:
a core layer for guiding an electromagnetic wave in a first propagation direction and a second propagation direction;
a cladding layer disposed at least partially about the core layer; and
a reflector in optical communication with the core layer for directing the electromagnetic wave from the first propagation direction to the second propagation direction.

9. The apparatus of claim 8, wherein the reflector is a diffraction grating.

10. The apparatus of claim 8, wherein the reflector is a photonic crystal reflector.

11. The apparatus of claim 8, wherein the core layer is continuous.

12. The apparatus of claim 8, wherein the reflector is positioned at least partially in the core layer.

13. The apparatus of claim 8, wherein the reflector is positioned at least partially in the cladding layer.

14. An optical waveguide, comprising:
a core layer for guiding an electromagnetic wave in a first direction and a second direction;
a cladding layer disposed about the core layer; and
means for directing the electromagnetic wave from the first direction to the second direction.

15. The optical waveguide of claim 14, wherein the means for directing the electromagnetic wave is a reflector.

16. The optical waveguide of claim 14, wherein the means for directing the electromagnetic wave is a diffraction grating.

17. The optical waveguide of claim 14, wherein the means for directing the electromagnetic wave is a photonic crystal reflector.

18. An apparatus, comprising:
means for storing data;
means for reading and/or writing data in association with the means for storing data; and
an optical waveguide for guiding an electromagnetic wave to the means for reading and/or writing data, the optical waveguide including an internal reflector for changing the propagation direction of the electromagnetic wave.

19. The apparatus of claim 18, wherein the optical waveguide is a flexible waveguide.

20. The apparatus of claim 18, wherein the core guiding layer is continuous.
